(19) United States
(12) Patent Application Publication
(10) Pub. No.: US 2005/0030386 A1
(43) Pub. Date: Feb. 10, 2005

(54) Method and apparatus for determining video formats supported by a digital television receiver

(76) Inventor: John Kamieniecki, Lafayette Hill, PA (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 10/633,781

(22) Filed: Aug. 4, 2003

(51) Int. Cl. H04N 5/232

(52) U.S. Cl. 348/211.3

(57) ABSTRACT

A method and apparatus is provided for providing a digital video image to a display device. The method begins by receiving a digital signal in a predefined video format from a service provider and comparing the predefined video format to a plurality of stored video formats supported by the display device. If the predefined video format matches one of the plurality of stored video formats supported by the display device, a decoded output signal is transmitted to the display device in the predefined video format for displaying the digital video image thereon. However, if the predefined video format does not match one of the plurality of stored video formats supported by the display device, a decoded output signal is transmitted to the display device in a selected one of the plurality of stored video formats.

### FIELD OF THE INVENTION

The present invention relates to a television signal receiver and decoder, hereafter referred to as a “set-top terminal,” with built-in analog and digital tuning and decoding.

### BACKGROUND OF THE INVENTION

The communication of digital cable services from program providers to end-users is accomplished through several steps. The first involves transmission of the digitally encoded services from broadcast service providers to cable service provider facilities. The second step involves manipulating video and audio data by the digital cable service provider using head-end equipment at their facility. The final step involves transmission of digital information to the end-user via a coaxial cable and decoding the transmission at the consumers' site. Head-end equipment at a cable operator facility provides received programs on specific channels that are broadcast to customers over copper cable and/or fiber optic cable, typically via hybrid fiber-cable (HFC) distribution plants. A set-top terminal located at the customer facility tunes and decodes incoming broadcasts. The set-top terminal tunes to a desired channel frequency and modulates the received signal onto an unused television channel (usually channel 3 or 4). In addition to digital information, the set top terminals generally also receive analog broadcasts that are transmitted using the NTSC format as provided in North America and Japan or PAL as provided in most of Europe.

Future digital television (DTV) receivers are expected to be implemented substantially in accordance with the transmission standards established by the Advanced Television Standards Committee (ATSC). A similar standard is the European Digital Video Broadcasting (DVB) standard. A compressed digital video system is described in the ATSC digital television standard document A/53, incorporated herein by reference. Moreover, the Moving Pictures Experts Group (MPEG) has promulgated several standards relating to digital data delivery systems. The first, known as MPEG-1, refers to ISO/IEC standards 11172 and is incorporated herein by reference. The second, known as MPEG-2, refers to ISO/IEC standards 13818 and is incorporated herein by reference.

This standard defines a complex syntax that contains a mixture of data and control information. Some of this control information is used to enable signals having several different formats (resolutions) to be covered by the standard. These formats define images having differing numbers of picture elements (pixels) per line, differing numbers of lines per frame or field, and differing numbers of frames or fields per second. These formats are typically referenced by the number of horizontal lines in the image and whether each image frame is formed from two fields, each containing alternate lines of the frame (interlaced) or from a single image field containing all of the lines of the frame (progressive). Listed from highest resolution to lowest resolution, the television signal formats defined by the ATSC standard, for example, are referenced by the designations, 1080I, 720P, 480P and 480I. In these designations, the number refers to the number of horizontal lines in the image and the letter defines the resulting image as being interlaced (I) or progressive (P). Thus, the new DTV standards support either high definition television (“HDTV”), wherein the video frames are of higher resolution than those used in present NTSC signals, or standard definition television (“SDTV”), e.g., television which has approximately the same resolution per frame as the existing analog NTSC standard.

Because these formats define different numbers of lines per image field or frame, they inherently change the way in which the display device operates. Some display devices, generically referred to as multisync monitors, can display more than one format. A broadcaster may change the format of the video content that it sends, for example, from 480I to 720P. If the viewer uses a set-top terminal with a multisync monitor, the viewer may also change the display format independently of the format of the received signal. Thus, the viewer who receives the 720P program may choose to display it as a 480P video sequence.

Set-top terminals generally receive all formats provided by the cable operator and convert them to a single format for display, or alternatively, the set-top terminals may operate in Native Mode. In Native Mode operation, the video signal is outputted to the display in the same format in which it is received. Thus, in Native Mode, a 1080i 16:9 broadcast signal received by the set-top terminal would be output to the display as a 1080i 16:9 signal and 480i 4:3 broadcast signal would be output as a 480i 4:3 video signal.

One problem with Native Mode operation is that many multisync monitors only a support a smaller subset of the possible broadcast formats. This is a problem because if the monitor does not support the inherent video format, the set-top terminal will output a signal that the monitor cannot decode. As a result the user will be unable to view the content. Moreover, the user may not know why the content is not being displayed. Because of this problem most set-top terminals are able to re-format the video signal, regardless of its initial format, to a format that is supported by the monitor. Unfortunately, this conversion process is not always loss-less and can give rise to artifacts and imperfections in the output video. Additionally, when a lower resolution format is converted to a higher resolution format the inherent resolution imperfections can be further magnified.

Accordingly, it would be desirable to provide a method and apparatus by which a set-top terminal can easily determine the video formats that supported by a display device.

### SUMMARY OF THE INVENTION

In accordance with the present invention, a method and apparatus is provided for providing a digital video image to a display device. The method begins by receiving a digital signal in a predefined video format from a service provider and comparing the predefined video format to a plurality of stored video formats supported by the display device. If the predefined video format matches one of the plurality of stored video formats supported by the display device, a decoded output signal is transmitted to the display device in the predefined video format for displaying the digital video image thereon. However, if the predefined video format does not match one of the plurality of stored video formats supported by the display device, a decoded output signal is transmitted to the display device in a selected one of the plurality of stored video formats that is selected at least in part based on the predefined video format.

In accordance with one aspect of the invention, the predefined video format is selected from the group consisting of 1080I, 720P, 480P and 480I formats.

In accordance with another aspect of the invention, the selected one of the plurality of stored video formats is a next best available format that is determined in accordance with predefined criteria.

In accordance with another aspect of the invention, the receiving, comparing and transmitting steps are performed by a digital set-top terminal.

In accordance with another aspect of the invention, the digital set-top box supports an analog video format.

In accordance with another aspect of the invention, the display device is a digital television receiver.

In accordance with another aspect of the invention, a method is provided for determining at least one video format of a digital video signal that is supported by a display device. The method begins by displaying an onscreen message to the display device in accordance with a first video format. Next, the first video format is stored if a user response to the message is received within a predetermined time period. The stored first video format is a format supported by the display device. The onscreen message is displayed to the display device in accordance with a second video format after expiration of the predetermined time period or after receiving the user response.

In accordance with another aspect of the invention, a setup mode is entered in which at least one video format supported by the display device is determined.

In accordance with another aspect of the invention, the onscreen message includes an image that allows the user to determine that the message is being correctly displayed.

In accordance with another aspect of the invention, the image is a predefined color.

In accordance with another aspect of the invention, image is a predefined shape.

In accordance with another aspect of the invention, the image is a predefined shape and color.

### BRIEF DESCRIPTION OF THE DRAWINGS

FIG. 1 shows a digital set-top terminal constructed in accordance with the present invention.

FIG. 2 shows a flowchart of the steps that may be performed in accordance with the present invention using the onscreen display to enter into the set-top terminal the formats supported by the display.

### DETAILED DESCRIPTION

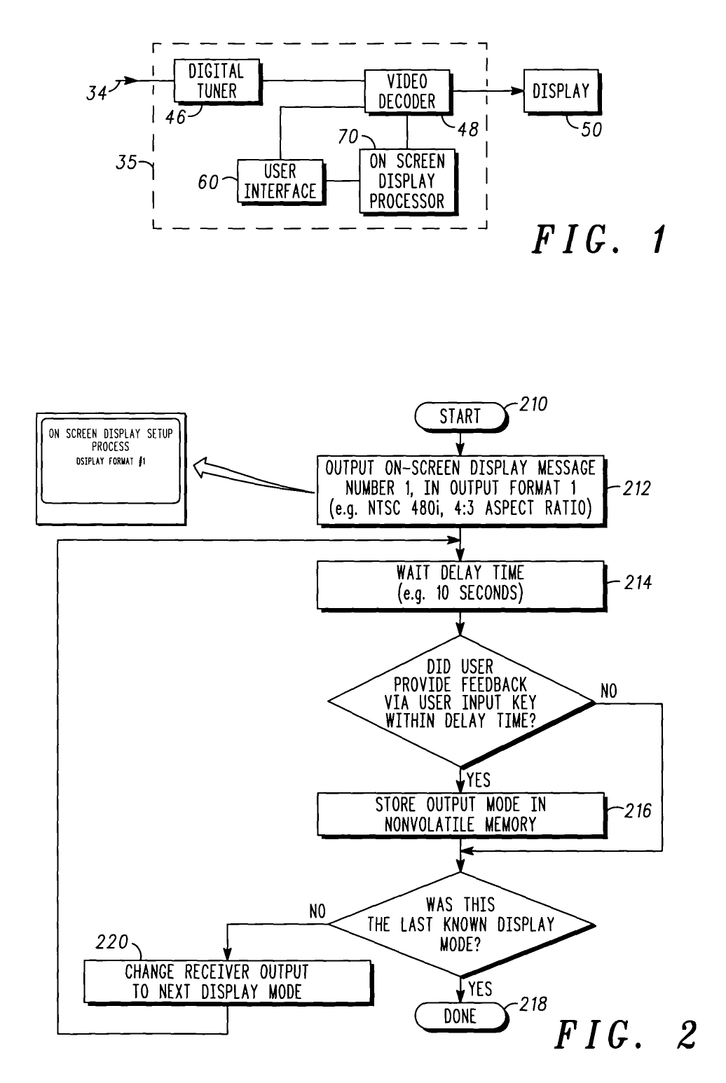

FIG. 1 shows a digital set-top terminal constructed in accordance with the present invention. Examples of commercially available set-top boxes in which the present invention may be incorporated include the Motorola Interactive Digital Set-top Terminal (DCT-5000, 5100 and 5200) series of units. These units offer digital video, audio, and high speed-data services along with streaming media, PPV, Internet services, HDTV, and personal video recorder (PVR) capabilities. Of course, the present invention may be used in connection with any digital set-top terminals and is not limited to the aforementioned units, which are presented by way of illustration only.

Digital set-top terminal 35 includes a digital tuner 46 for tuning to a desired digital television channel from the band of television signals received by the set-top 35 via input 34. Decryption and decompression hardware and associated software are included in the video decoder 48 for decoding the tuned digital signal (e.g. an MPEG-2 television signal) prior to sending it to the display 50. The digital set-top terminal also includes a user interface processor 60 and an onscreen display processor 70 for displaying information such as control menus and channel guides, for example.

While not shown in FIG. 1, it will be recognized that the digital set-top terminal 35 will generally also include an analog tuner to decode and display analog video, which is typically provided to the display 50 in the 480i format

It is contemplated that the video decoder 48, user interface processor 60 and onscreen display processor 70 may each be implemented in hardware, software or a combination thereof. In addition, although the video decoder 48, user interface processor 60 and onscreen display processor 70 are shown as separate processors, it is contemplated that they may be combined and implemented as separate processes on one, two or more processors.

In accordance with the present invention, the digital set-top terminal is provided with a user setup/calibration process in which the user can enter all the formats supported by the user's display. This information, which is stored in the set-top terminal, is used to enhance native mode operation. Specifically, the set-top terminal can offer native mode operation anytime the video signal received from the cable operator is in a format that is supported by the display. In the event that the display cannot support the native format, the set-top terminal can select the next best format from among those that are supported by the display.

The user may enter into the set-top terminal the formats supported by the display in any of a variety of different ways. For example, an advanced user may enter the information directly into the set-top terminal via the user interface 60. For the less experienced user, the onscreen display can guide the user through a series of steps to determine the formats supported by the user's display.

FIG. 2 shows a flowchart of the steps that may be performed using the onscreen display to enter into the set-top terminal the formats supported by the display. The method begins in step 210 by entering a setup mode, which may be entered manually by the user at any time via the user interface 60 or automatically upon initialization of the set-top terminal. As a preliminary matter, it should be noted that the method must overcome the problem that the set-up instructions cannot be displayed on the display unless the set-top terminal knows of at least one format that the display supports. The set-top terminal overcomes this problem by cycling through the various available formats. That is, under the direction of the onscreen display processor 70 the set-top terminal outputs the video signal to the display in different formats in a sequential manner. Specifically, in step 212 the set-top terminal displays a message in a first video format. The message contains instructions for the user to follow if the user can see the message. For example, as indicated in FIG. 2, the message may simply say “If you can successfully view this image, please press the enter key on your remote control or front panel.” In some cases the message may contain additional instructions to ensure that the user is viewing the correct image. For example, the onscreen display processor may display specific colors and/shapes (e.g., a green square) and the user may asked to respond to the message “You should now see a green square in the center of your screen.” These additional instructions prevent the user from providing positive feedback in the event that the image is somewhat viewable but distorted due to formatting incompatibilities. The colors and/or shapes can be used to verify that the output colors and aspect ratios are being correctly displayed.

If the user does not see the displayed message, or does not see it correctly as indicated by their response to additional questioning, then presumably that format is not supported by the display. In step 214, the user is given a predetermined amount of time (e.g., 10 seconds) to provide the feedback requested by the message. If the user provides the requested response, then in step 216 the set-top terminal stores that video format in nonvolatile memory (not shown in FIG. 1). The set-top terminal then determines if it has displayed the last available video format. If so, the setup process ends in step 218. Otherwise, if the set-top terminal has more video formats available that it has not yet displayed when the predetermined delay has lapsed, the set-top terminal increments to the next video format in step 220 and repeats the process by displaying the message in the next video format.

Once the set-up process has been completed the set-top terminal will select the video format to be supplied to the display in the following manner. First, the terminal will determine the inherent format in which the video signal is received from the cable operator and compare that format to the stored formats supported by the display. If the inherent format is available then the set-top terminal will transmit the video signal to the display in that format. If the inherent format is not available, the set-top terminal will select the next best format from among those that are supported by the display. The format that is deemed to be the next best may be determined in accordance with a variety of different criteria, but generally it will be a format that gives the user the best possible image. It should be noted that due to differences in the formats and screen aspect ratios (e.g., 4:3 vs. 16:9) the best available format may not always be the one that results in the highest resolution.

As previously mentioned, the digital set-top terminal 35 will generally also include an analog tuner to decode and display analog video, which is typically provided to the display 50 in the 480i format. However, if the display that is employed does not support the 480i format, then the set-top terminal 35 can convert the signal to another suitable format in the same manner presented above in connection with a digital signal.

1. A method for providing a digital video image to a display device, said method comprising the steps of:
receiving a digital signal in a predefined video format from a service provider;
comparing said predefined video format to a plurality of stored video formats supported by the display device;
if said predefined video format matches one of the plurality of stored video formats supported by the display device, transmitting a decoded output signal to the display device in said predefined video format for displaying the digital video image thereon; and
if said predefined video format does not match one of the plurality of stored video formats supported by the display device, transmitting a decoded output signal to the display device in a selected one of the plurality of stored video formats that is selected at least in part based on said predefined video format.

2. The method of claim 1 wherein said predefined video format is selected from the group consisting of 1080I, 720P, 480P and 480I formats.

3. The method of claim 1 wherein said selected one of the plurality of stored video formats is a next best available format that is determined in accordance with predefined criteria.

4. The method of claim 1 wherein said receiving, comparing and transmitting steps are performed by a digital set-top terminal.

5. The method of claim 4 wherein said digital set-top box supports an analog video format.

6. The method of claim 1 wherein said display device is a digital television receiver.

7. A method for determining at least one video format of a digital video signal that is supported by a display device, said method comprising the steps of:
a. displaying an onscreen message to the display device in accordance with a first video format;
b. storing the first video format if a user response to the message is received within a predetermined time period, said stored first video format being supported by the display device;
c. displaying the onscreen message to the display device in accordance with a second video format after expiration of the predetermined time period or after receiving the user response.

8. The method of claim 7 further comprising the steps of repeating steps (a)-(c) for all available video formats.

9. The method of claim 7 further comprising the step of entering a setup mode in which the at least one video format supported by the display device is determined.

10. The method of claim 7 wherein said onscreen message includes a user instruction informing a user to indicate that the first video format is supported by the display device if the message is understood.

11. The method of claim 7 wherein said display device is a digital television receiver.

12. The method of claim 10 wherein said onscreen message includes an image that allows the user to determine that the message is being correctly displayed.

13. The method of claim 12 wherein said image is a predefined color.

14. The method of claim 12 wherein said image is a predefined shape.

15. The method of claim 12 wherein said image is a predefined shape and color.

16. The method of claim 7 wherein the first video format is stored in nonvolatile memory.

17. The method of claim 7 wherein said user response is entered via a keypad.

18. The method of claim 7 wherein said first video format is selected from the group consisting of 1080I, 720P, 480P and 480I formats.

19. The method of claim 7 wherein said displaying and storing steps are performed by a digital set-top terminal.

20. The method of claim 19 wherein said digital set-top terminal supports analog video format.

21. An apparatus for use with a digital television receiver, comprising:
a digital tuner for receiving a digital television signal in a predefined video format from a service provider;
a video decoder for receiving the digital television signal from the digital tuner and providing to the digital television receiver a video output signal;
a user interface coupled to the video decoder;
an onscreen display processor for determining with user input via the user interface a plurality of video formats that are supported by the digital television receiver; and
wherein said video decoder provides the video output signal to the digital television receiver in said predefined format if said predefined video format matches one of said plurality of video formats supported by the digital television receiver and provides the video output signal to the digital television receiver in a selected one of the plurality of video formats supported by the digital television receiver if said predefined video format does not match one of the plurality of video formats supported by the digital television receiver.

22. The apparatus of claim 21 wherein said predefined video format is selected from the group consisting of 1080I, 720P, 480P and 480I formats.

23. The apparatus of claim 21 wherein said selected one of the plurality of stored video formats is a next best available format that is determined in accordance with predefined criteria.

24. The apparatus of claim 21 wherein said onscreen display processor
a. displays an onscreen message to the digital television receiver in accordance with a first video format;
b. stores the first video format if a user response to the message is received via the user interface within a predetermined time period, said stored first video format being supported by the digital television receiver;
c. displays the onscreen message to the digital television receiver in accordance with a second video format after expiration of the predetermined time period or after receiving the user response.

25. The apparatus of claim 24 wherein said onscreen display processor enters a setup mode in which the at least one video format supported by the digital television receiver is determined.

26. The apparatus of claim 24 wherein said onscreen message includes a user instruction informing a user to indicate that the first video format is supported by the digital television receiver if the message is understood.

27. The apparatus of claim 24 wherein said onscreen message includes an image that allows the user to determine that the message is being correctly displayed.

28. The apparatus of claim 27 wherein said image is a predefined color.

29. The apparatus of claim 27 wherein said image is a predefined shape.

30. The apparatus of claim 27 wherein said image is a predefined shape and color.

31. The apparatus of claim 24 wherein the first video format is stored in nonvolatile memory.

32. The apparatus of claim 21 wherein said user interface includes a keypad.

33. The apparatus of claim 21 wherein said predefined video format is selected from the group consisting of 1080I, 720P, 480P and 480I formats.

34. The apparatus of claim 24 wherein said first video format is selected from the group consisting of 1080I, 720P, 480P and 480I formats.

35. The apparatus of claim 21 further comprising an analog tuner for receiving an analog television signal.
